(19) United States
(12) Patent Application Publication
(10) Pub. No.: US 2025/0168038 A1
(43) Pub. Date: May 22, 2025

(54) MANAGEMENT OF PRIVATE NETWORK ADDRESSING FOR A COMPUTING ELEMENT IN MULTIPLE PRIVATE NETWORKS

(71) Applicant: Tailscale Inc., Toronto (CA)

(72) Inventors: Maisem J. Ali, Woodinville, WA (US); David Anderson, Sooke (CA); Bradley J. Fitzpatrick, Seattle, WA (US)

(21) Appl. No.: 18/896,445

(22) Filed: Sep. 25, 2024

Related U.S. Application Data
(60) Provisional application No. 63/601,952, filed on Nov. 22, 2023.

(51) Int. Cl. H04L 12/46

(52) U.S. Cl. CPC H04L 12/4633

(57) ABSTRACT

Described herein are systems, methods, and software to manage source addressing associated with packets communicated across multiple private networks. In one example, a computing element is configured to identify a packet from a process with a first source IP address and determine a destination private network from a plurality of private networks for the packet. When the destination private network is not the primary private network, the computing element performs network address translation to translate the first source IP address to a second source IP address for the secondary private network. Once translation is performed, the computing element encapsulates the packet with the second source IP address and communicates the packet.

### RELATED APPLICATIONS

This application is related to and claims priority to U.S. Provisional Patent Application 63/601,952, titled “MANAGEMENT OF PRIVATE NETWORK ADDRESSING FOR A COMPUTING ELEMENT IN MULTIPLE PRIVATE NETWORKS,” filed Nov. 22, 2023, and which is hereby incorporated by reference in its entirety.

### TECHNICAL BACKGROUND

In computing networks, physical and virtual computing systems or computing elements include applications and services that require communications with other computing systems to provide desired operations. For example, an application on a first computing system may require data from a storage server located on a second computing system. To provide the communication, the data payload may be placed in a network packet and transferred to the required computing system. However, although network packets provide a method of communication between computing systems, difficulties often arise in maintaining security and configuration information to support the communications.

To overcome some of the deficiencies presented in securing network communications, various technologies have been developed. These technologies include virtual local area networks (VLANs), encryption for the data payload within the data packets, amongst other similar security procedures. Yet, while these security technologies may provide additional security over unprotected network packets, configuring private networks can be difficult and cumbersome. These difficulties are compounded as the number of virtual and physical computing elements are increased in a network, requiring increased management in association with addressing for the computing elements. Additionally, computing elements have difficulties in managing communications across multiple private networks.

### SUMMARY

The technology described herein manages source IP addressing for networking across multiple private networks. In one example, a method includes identifying a packet from a process on the computing element with a first source IP address and identifying a destination private network from a plurality of private networks for the packet. The method determines whether the destination private network is a primary private network or a secondary private network. When the destination private network is a primary private network, the method includes encapsulating the packet with the first source IP address and communicating the encapsulated packet toward a destination computing element. When the destination private network is in a secondary private network, the method provides for performing network address translation to translate the first source IP address to a second source IP address for the secondary private network, encapsulating the packet with the second source IP address, and communicating the encapsulated packet toward a destination computing element.

### BRIEF DESCRIPTION OF THE DRAWINGS

FIG. 1 illustrates a computing environment to manage private network communications across multiple private networks according to an implementation.

FIG. 2 illustrates an operation of a computing element to manage private network communications across multiple private networks according to an implementation.

FIG. 3 illustrates a timing diagram to manage egress packets for private networks according to an implementation.

FIG. 4 illustrates an operational scenario of managing and processing egress packets for private networks according to an implementation.

FIG. 5 illustrates an operational scenario of managing and processing egress packets for private networks according to an implementation.

FIG. 6 illustrates a computing system to process and manage egress packets for different private networks according to an implementation.

### DETAILED DESCRIPTION

Private networks are restricted computer networks designed for controlled and secure communication and data sharing within specific groups or organizations. They provide restricted access, enhanced security measures, and a controlled environment, allowing authorized users and devices to exchange data and resources while protecting against unauthorized access or cyberattacks. Private networks can be localized within a single office or span across multiple locations, and they are often used by businesses, government agencies, educational institutions, and other organizations to safeguard the privacy, security, and integrity of their internal communications and data.

For some private networks, a coordination service is deployed that distributes and manages the addressing information for the different computing elements available in the private network. In at least one implementation, a first computing element will request to join at least one private network by communicating with the coordination service. In response to the request, the coordination service will identify communication information for the first computing element and provide the communication information to the first computing element. The communication information includes public addressing information for communicating with other computing elements, public encryption key information for communicating with the other computing elements, and private addressing information for communicating with the other computing elements. The private addressing information is allocated by the coordination service to each of the computing elements in the private networks and comprises at least a private IP address.

For example, when the first computing element registers with the coordination service, the coordination service allocates at least one private IP address to the first computing element. The computing element will be allocated a private IP address for each private network associated with the computing element. Thus, if the first computing element belongs to two different private networks, the coordination service will allocate two private IP addresses, one for each of the networks. The coordination service will also indicate a primary private network and primary private IP address for use by the first computing element, permitting applications to use a single private source IP address.

When an application or service on the first computing element generates a packet directed to a second computing element in a private network, the packet will include a source private IP address allocated to the first computing element and associated with the primary private network. The packet will further include a destination private IP address associated with the second computing element. Once the packet is generated, a private networking service on the first computing element identifies the packet and determines whether the packet is destined for a computing element in the primary private network, or an alternative private network based on the private destination IP address included in the packet.

If the private destination IP address corresponds to the primary private network, then the private networking service encapsulates the packet using at least the public encryption key information for the second computing element. The encapsulation can comprise encrypting the packet in a payload of a second packet using the public encryption key and adding a header to the second packet that includes the public addressing information required for the public network communication between the first computing element and the second computing element. Once the second packet is generated, the second packet is communicated to the second computing element.

If the private destination IP address corresponds to an alternative private network, then the private networking service performs network address translation on the private source IP address. The network address translation translates and replaces the private source IP address with a second private source IP address associated with the alternative network. Advantageously, the applications and other services on the first computing element will use a single source IP address presented by the networking service (associated with the private network), while the private networking service translates and converts the source IP address as required to support additional private networks. Once replaced, the private networking service encapsulates the packet using at least the public encryption key information for the second computing element. The encapsulation can comprise encrypting the packet in a payload of a second packet using the public encryption key and adding a header to the second packet that includes the public addressing information required for the public network communication between the first computing element and the second computing element. Once the second packet is generated, the second packet is communicated to the second computing element.

In some implementations, in addition to performing the network address translation in association with egress packets from the first computing element to other computing elements in the private networks, network address translation is also performed for packets received from second computing elements. In at least one example, the first computing element will receive an encapsulated packet from another computing element and decapsulate the packet using a private encryption key available on the device. Once decrypted, the addressing of the decrypted packet is checked to determine whether a translation is required for the destination private IP address (i.e., address of the first computing element). If the destination IP address is not the primary private IP address, then network address translation is performed to change the IP address to the primary private IP address. In contrast, if the destination IP address is the primary private IP address (or the address for the primary private network), then no network address translation is performed, and the packet is forwarded to the destination service or application on the computing element.

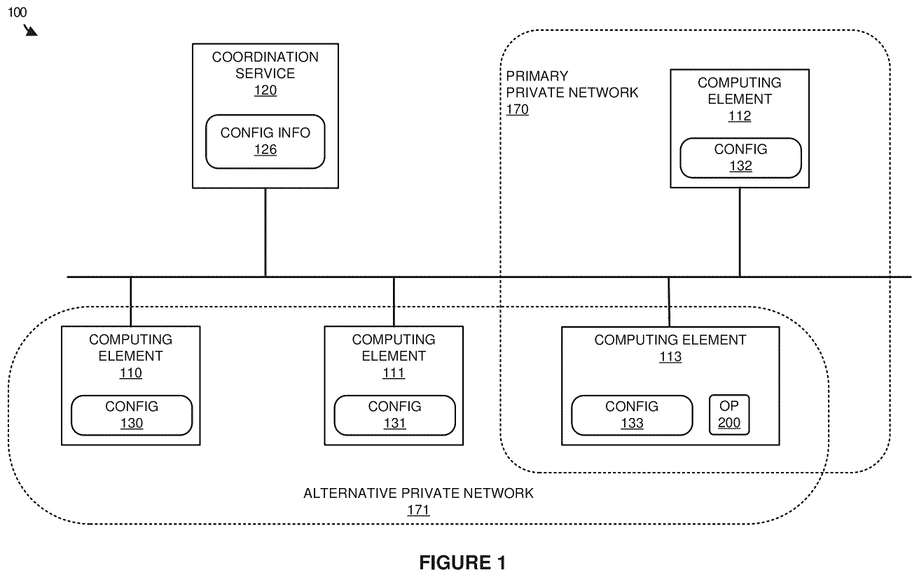

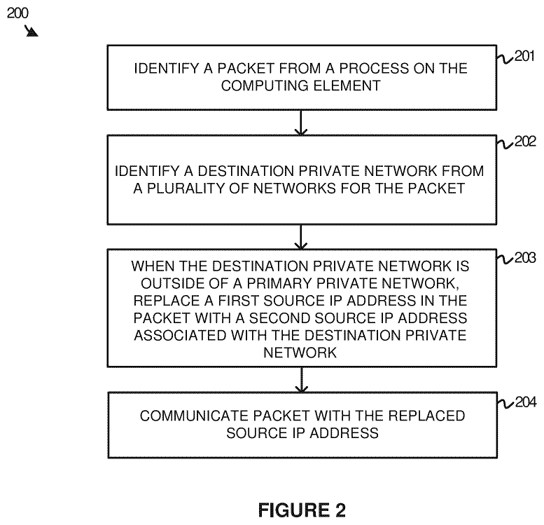

FIG. 1 illustrates a computing environment 100 to manage private network communications across multiple private networks according to an implementation. Computing environment 100 includes coordination service 120, computing elements 110-113, and private networks 170-171. Coordination service 120 includes configuration information 126 and can be employed using one or more computers. Computing elements 110-113 each include a corresponding configuration of configurations 130-133 and computing element 113 provides operation 200 that is further described below with respect to FIG. 2. Computing elements 110 can comprise physical computers, virtual machines, containers, or some other computing element.

In computing environment 100, computing elements 110-113 communicate using private networks configured at least in part via configurations 130-133 provided by coordination service 120 using configuration information 126. Configurations 130-133 can include private IP addressing information, public IP addressing information, encryption keys, port information, permissions, or some other information to communicate in a private network. For example, when computing element 113 provides information to join primary private network 170 (e.g., token, username, password, or some other information), coordination service 120 can identify the configuration information for computing element 113. The configuration information, represented as part of configuration 133, can include a public IP address associated with computing element 112, a private IP address associated with computing element 112, a public encryption key associated with computing element 112, permission information (e.g., available ports), or some other information for computing element to permit computing element 113 to communicate with computing element 112. In addition to providing the configuration to computing element 113, coordination service 120 can further update computing element 112 to communicate with computing element 113. Specifically, computing element 113 can provide public communication information to coordination service 120 (e.g., public IP address and a generated public key that corresponds to a private key maintained locally at computing element 113). Coordination service 120 can determine a private IP address for computing element 113 (such as an available IP address for primary private network 170) and provide the public and private communication information and encryption keys to computing element 112 to update configuration 132.

Similar operations can be performed in association with alternative private network 171. In some implementations, computing element 113 may be required to provide separate credentials for each of the private networks. In other implementations, computing element 113 will only be required to provide a single set of credentials. For example, a user associated with computing element can use a Google™ profile to sign in and coordination service 120 can identify and provide the required information for multiple networks.

After the configuration is provided to computing element 113, computing element 113 can generate private network packets destined to computing elements in either private network. When a communication request is generated to communicate with computing element 112, the application associated with the computing element 113 can generate a first packet using a source private IP address associated with computing element 113 and a destination private IP address associated with computing element 112. After the first packet is generated, the first packet is encapsulated using the public key associated with computing element 112 and communicated to computing element 112 using the public addressing information associated with computing elements 112-113 in the encapsulation header of the packet.

Here, computing element 113 is assigned two private IP addresses that permit computing element 113 to communicate in both private networks 170-171, wherein a first private IP address will be the default address that is used by applications and services on computing element 113. When a first packet is generated, configuration 133 can be used to determine whether the destination computing element for the packet resides in primary private network 170 or alternative private network 171. In some implementations, the determination can be made based on the destination private IP address in the communication. For example, the configuration provided by coordination service 120 can indicate the computing elements that are available in different networks and indicate the private address that should be used in association with communications for the different network. For example, when an application on computing element 113 generates a request to communicate with computing element 111, the application can use a first source IP address (i.e., first source IP address associated with primary private network 170). Once the communication or packet is generated, computing element 113 can determine whether the destination private address for the packet is in the primary private network 170 or the alternative private network 171. If the packet is destined for a computing element in primary private network 170, such as computing element 112, then the packet is encapsulated with the first source IP address for the primary private network. In contrast, if the packet is destined for a computing element in alternative private network 171, computing element 113 will use configuration 133 to perform a source network address translation on the packet, encapsulate the packet in accordance with the requirements of alternative private network 171.

Additionally, when a packet is received at computing element 113, configuration 133 can be used to perform network address translation on the address if required. Specifically, if the packet is received from a computing element in alternative private network 171, computing element 113 can translate the destination IP address from a first address associated with computing element 113 in alternative private network 171 to a second address associated with computing element 113 in primary private network 170. Advantageously, while the processes or applications on computing element 113 can use a single source IP address as if the computing element is in a single private network, configuration 133 and operation 200 can be used to change the source IP address to support different private networks.

FIG. 2 illustrates an operation 200 of a computing element to manage private network communications across multiple private networks according to an implementation. The steps of operation 200 are referenced parenthetically in the paragraphs that follow with reference to elements and systems in computing environment 100.

In operation 200, computing element 113 identifies (201) a packet from a process on the computing element, wherein the packet comprises a first private source IP address and a destination private IP address. The source and destination IP addresses correspond to private network addresses distributed as part of the configuration from coordination service 120. Specifically, each computing element of computing elements 110-113 can be assigned one or more private IP addresses. For example, computing element 113 is assigned a first IP address for use in association with primary private network 170 and a second IP address for use in association with alternative private network 171. For the processes and applications on computing element 113 only a single source IP address (i.e., the source private IP address for primary private network 170) is indicated, and the networking process represented by operation 200 performs any required network address translation.

After identifying the packet from the process on the computing element, operation 200 further identifies (202) a destination private network from a plurality of private networks for the packet. In some implementations, the destination private network can be determined based on the process or application making the request, the destination private IP address for the packet, any port information for the packet, or some other information from the packet. The information for the packet can be compared to configuration 133 to determine whether the destination is in primary private network 170 or alternative private network 171. For example, when a packet is generated on computing element 113, operation 200 identifies the destination IP address for the packet and determines whether the destination is in primary private network 170 or alternative private network 171.

When the destination private network is outside of a primary private network, operation 200 further replaces (203) a first source IP address in the packet with a second source IP address associated with the destination private network. As an example, when a packet is first generated by an application on computing element 113, the packet can include a source IP address associated with primary private network 170. When the destination address is for computing element in alternative private network 171, operation 200 translates the source IP address to the source IP address for alternative private network 171. Thus, to identify computing element 113, operation 200 uses the source IP address that is recognizable in alternative private network 171. Once the source IP address is replaced, operation 200 further communicates (204) the packet with the replaced source IP address toward the destination computing element.

In some implementations, when the packet is directed to a destination computing element in alternative private network 171, operation 200 replaces the source IP address (default for primary private network 170) with the alternative source IP address for the alternative private network 171. Once replaced, the computing element encapsulates the packet using a public encryption key associated with the destination computing element, adds public addressing information to the packet (e.g., IP addressing, MAC addressing, and the like), and communicates the packet toward the destination computing element.

In some examples, when computing element 113 is in two different private networks, coordination service 120 manages the private destination IP addresses to ensure that each of the available devices correspond to a unique destination. Thus, computing element 113 is available to communicate with computing elements 110-112 and each of the computing elements is allocated a unique private IP address by coordination service 120. Accordingly, based on the destination private IP address in the packet, computing element 113 determines whether to use a first source private IP address associated with primary private network 170 or a second source private IP address associated with alternative private network 171.

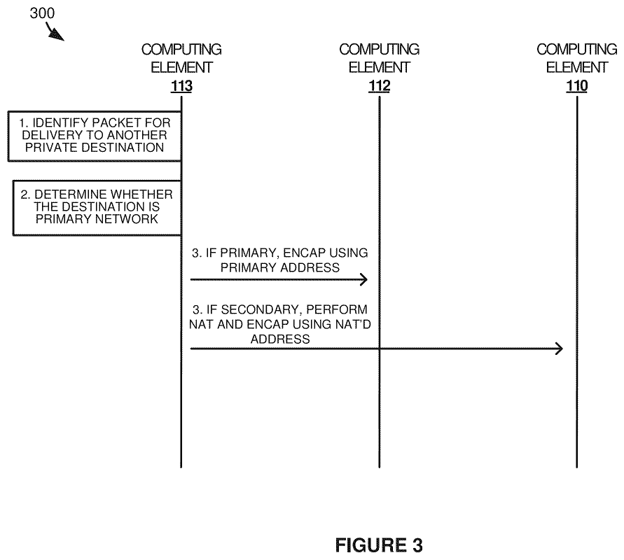

FIG. 3 illustrates a timing diagram 300 to manage egress packets for private networks according to an implementation. Timing diagram 300 includes computing element 113, computing element 112, and computing element 110 from computing environment 100 of FIG. 1.

At step 1, computing element 113 identifies a packet for delivery to a destination in a private network. In some implementations, computing element 113 identifies that the destination is in a private network based on the destination IP address used in the packet. For example, while a first packet uses a public IP address as a destination, a second packet will use a private IP address allocated by the coordination service for use in one of the available private networks. In response to identifying the packet, computing element 113 determines whether the destination computing element is in the primary private network or an alternative private network at step 2.

If the packet is destined for a computing element in the primary network, then computing element 113 encapsulates the packet with the source private IP address for the primary network. Once encapsulated, computing element 113 communicates the packet to computing element 112 that is in the primary private network. When a packet is destined in the primary private network, computing element 113 does not translate the source private IP address in the identified packet. Rather, computing element 113 maintains the addressing of the packet (source and destination private IP addresses), encapsulates the packet by encrypting the packet and adding public addressing information, and communicating the packet toward computing element 112. The public addressing information comprises a source public IP address for computing element 113, a destination public IP address for computing element 112, MAC and protocol information, or some other public addressing information. In some implementations, the coordination service provides the private addressing information for the available computing elements, the public addressing information for the available computing elements, and other communication information for the private networks to computing element 113. The coordination service further provides communication information to the other computing elements in the private networks to permit available communications in the private networks.

In another example of step 3, when the packet is destined for a computing element in the alternative private network, computing element 113 performs network address translation on the source private IP address. The network address translation converts the source private IP address, used in association with the primary private network, to the source private IP address associated with the alternative private network. Once translated, the packet is encapsulated by encrypting the packet and adding public addressing information to the encryption header. The encryption uses a public key associated with the computing element. The addressing information includes public source and destination IP addressing, MAC addressing, protocol, or some other addressing information. Once encapsulated, computing element 113 communicates the encapsulated packet to computing element 110 as part of step 3.

In some implementations, the coordination service manages the communication information that is provided to each computing element in the private network. The communication information includes private addressing information, public addressing information, encryption key information, or some other information. The private addressing information comprises at least source and destination IP addressing information allocated by the coordination service, while the public addressing information comprises the public IP addressing information provided by each of the computing elements. The encryption key information comprises public encryption keys generated by the computing elements that are distributed to other computing elements in the corresponding private network. Each computing element will maintain the local private key to decrypt packets received in the private network that corresponds to the distributed public encryption key.

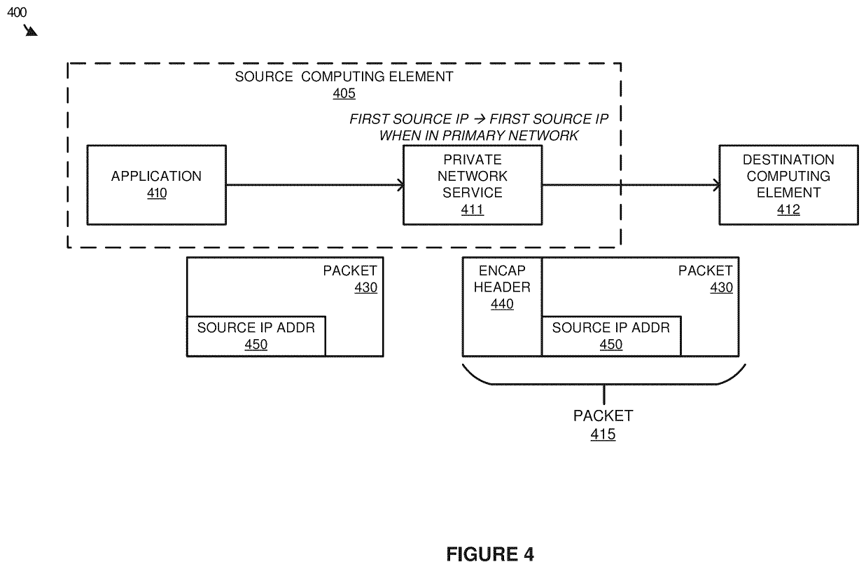

FIG. 4 illustrates an operational scenario 400 of managing and processing egress packets for private networks according to an implementation. Operational scenario 400 includes source computing element 405, destination computing element 412, packet 430, and packet 415. Source computing element 405 comprises application 410 and private network service 411. Packet 430 further comprises source IP address 450. Packet 415 is representative of a packet that encapsulates packet 430 and further includes encapsulation header 440.

In operational scenario 400, application 410 generates packet 430 with source IP address 450 that is provided to private network service 411. Private network service 411 operates as part of the operating system, as part of a daemon, or by some other service available to identify packets from application 410. Application 410 represents a database application, web service, video editing application, image editing application, or some other application on source computing element 405. In response to identifying packet 430, private network service 411 determines whether the packet is destined for a computing element in a primary private network or an alternative private network. In some implementations, the applications on source computing element 405 use a single source IP address for generating packets (i.e., the private source IP address associated with the primary network). Advantageously, the applications the packets that are processes and translated as required by private network service 411. In determining whether the destination of the packet is in the primary private network or an alternative private network, private network service 411 includes a configuration that identifies the destination IP address for the packet. If the destination IP address corresponds to the primary private network, then no network address translation is required. In contrast, if the destination IP address corresponds to an alternative private network, then network address translation is performed on the source private IP address to change the source IP address to the address expected by the destination computing element.

Here, private network service 411 determines that destination computing element 412 is in the primary private network with source computing element 405. Accordingly, no address translation is required for the packet. Once determined, private network service 411 encapsulates packet 430 with source IP address 450 as packet 415 and communicates the packet 415 toward destination computing element 412. Packet 415 encrypts packet 430 using the public encryption key information associated with destination computing element 412 and adds encapsulation header 440. Encapsulation header 440 includes public addressing information to communicate the packet over the public network, wherein the public addressing information includes at least a public IP address for source computing element 405 and a destination IP address for destination computing element 412.

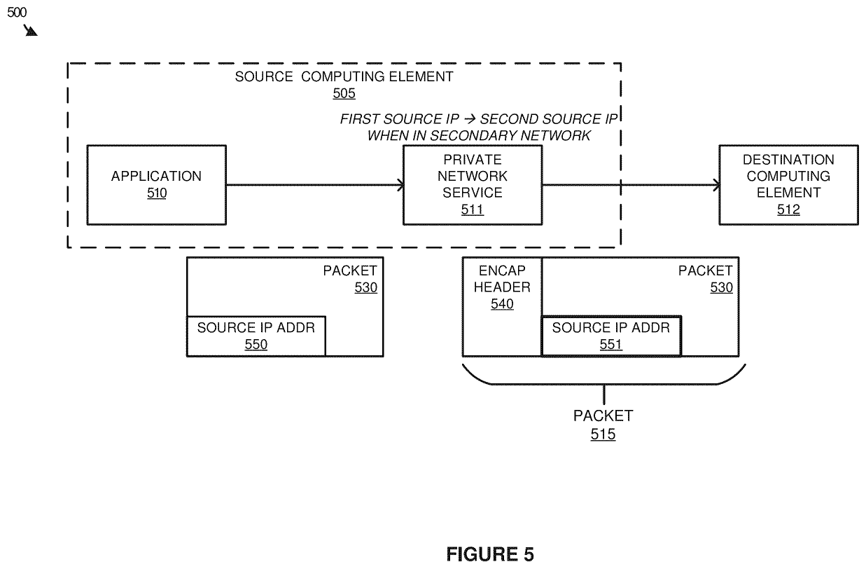

FIG. 5 illustrates an operational scenario 500 of managing and processing egress packets for private networks according to an implementation. Operational scenario 500 includes source computing element 505, destination computing element 512, packet 530, and packet 515. Source computing element 505 comprises application 510 and private network service 511. Packet 530 further comprises source IP address 550. Packet 515 is representative of a packet that encapsulates packet 530 and further includes encapsulation header 540 and a replacement source IP address 551.

In operational scenario 500, application 510 generates packet 530 with source IP address 550 that is provided to private network service 511. Private network service 511 operates as part of the operating system, as part of a daemon, or by some other service available to identify packets from application 510. Application 510 represents a database application, web service, video editing application, image editing application, or some other application on source computing element 505. In response to identifying packet 530, private network service 511 determines whether the packet is destined for a computing element in a primary private network or an alternative private network. In some implementations, the applications on source computing element 505 use a single source IP address for generating packets (i.e., the private source IP address associated with the primary network). Advantageously, the applications use a single address and rely on the private communication service to provide the translations required for the different private networks. In determining whether the destination of the packet is in the primary private network or an alternative private network, private network service 511 includes a configuration that identifies the destination IP address for the packet. If the destination IP address corresponds to the primary private network, then no network address translation is required. In contrast, if the destination IP address corresponds to an alternative private network, then network address translation is performed on the source private IP address to change the source IP address to the address expected by the destination computing element.

Here, private network service 511 determines that packet 530 is directed to destination computing element 512 in an alternative private network. Specifically, the destination IP address in packet 530 corresponds to a private IP address allocated to destination computing element 512 from an alternative private network. Private network service 511 is provided with a configuration from a coordination service that indicates whether network address translation is required (i.e., the destination IP address is in an alternative private network). When private network service 511 determines that the destination is in the alternative private network, private network service 511 performs network address translation to convert source IP address 550 to source IP address 551. Source IP address 551 corresponds to the alternative private network and is configurable via the coordination service. Once the source IP address is converted or translated, packet 530 is encapsulated and forwarded to destination computing element 512. Encapsulation includes encrypting packet 530 and source IP address 551 using the public encryption key associated with destination computing element 512 and adding encapsulation header 540. Encapsulation header 540 includes public addressing information associated with source computing element 505 and destination computing element 512. The public addressing information is provided as part of the communication information from the coordination service with the private addressing information (private IP addresses), encryption key information for the devices, or some other communication information for the private networks.

Although demonstrated in the examples of FIGS. 4 and 5 using egress packets communicated to a destination computing element, similar operations are performed for packets that are received from computing elements. Using the example of FIG. 5, when an encapsulated packet is received from a computing element in a private network, source computing element 505 decapsulates the packet and determines whether the packet originated from a computing element in the primary private network, or the alternative private network based on the private source IP address included in the decapsulated packet. As an example, when an encapsulated packet is received at source computing element 505, source computing element 505 decapsulates the packet and identifies the private source IP address in the decapsulated packet. Source computing element 505 determines whether the source IP is associated with a computing element in the primary private network or an alternative private network. If the source of the packet is from the primary network, then no address translation will be performed on the destination private IP address. Alternatively, if the source of the packet is from an alternative private network, then source computing element 505 will translate and replace the destination IP address with the destination IP address associated with the primary private network. Advantageously, the local applications at a computing element can use a single private IP address (i.e., private IP address associated with the primary private network) while private network service 511 manages the translation of the private address as required for other private networks. The translation of the address is provided for both egress packets from the computing element and ingress packets for the computing element.

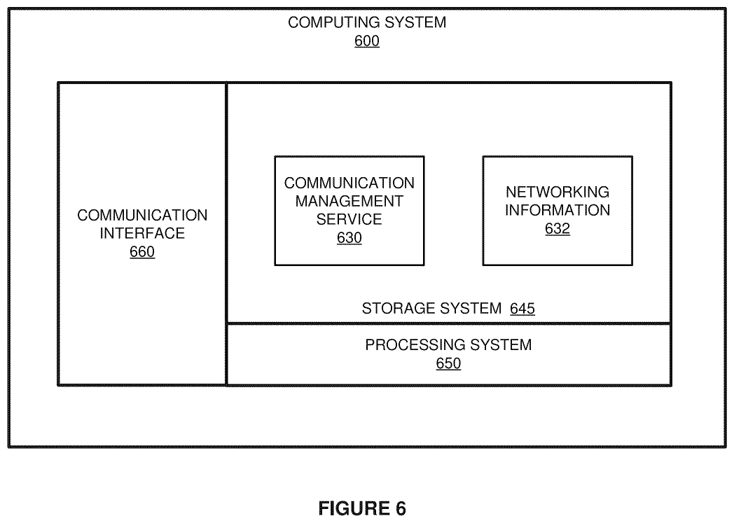

FIG. 6 illustrates a computing system 600 to process and manage egress packets for different private networks according to an implementation. Computing system 600 is representative of any computing system or systems with which the various operational architectures, processes, scenarios, and sequences disclosed herein for a computing element can be implemented. Computing system 600 is an example of computing elements 110-113 of FIG. 1, although other examples may exist. Computing system 600 includes storage system 645, processing system 650, and communication interface 660. Processing system 650 is operatively linked to communication interface 660 and storage system 645. Communication interface 660 may be communicatively linked to storage system 645 in some implementations. Computing system 600 may further include other components such as a battery and enclosure that are not shown for clarity.

Communication interface 660 comprises components that communicate over communication links, such as network cards, ports, radio frequency (RF), processing circuitry and software, or some other communication devices. Communication interface 660 may be configured to communicate over metallic, wireless, or optical links. Communication interface 660 may be configured to use Time Division Multiplex (TDM), Internet Protocol (IP), Ethernet, optical networking, wireless protocols, communication signaling, or some other communication format-including combinations thereof. Communication interface 660 may be configured to communicate with other computing systems (both physical and/or virtual) and a coordination service to obtain a configuration for computing system 600.

Processing system 650 comprises microprocessor and other circuitry that retrieves and executes operating software from storage system 645. Storage system 645 may include volatile and nonvolatile, removable, and non-removable computer-readable storage media implemented in any method or technology for storage of information, such as computer readable instructions, data structures, program modules, or other data. Storage system 645 may be implemented as a single storage device but may also be implemented across multiple storage devices or sub-systems. Storage system 645 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case would a computer readable storage medium of storage system 645, or any other computer readable storage medium herein, be considered a transitory form of signal transmission (often referred to as “signals per se”), such as a propagating electrical or electromagnetic signal or carrier wave.

Processing system 650 is typically mounted on a circuit board that may also hold the storage system. The operating software of storage system 645 comprises computer programs, firmware, or some other form of machine-readable program instructions. The operating software of storage system 645 comprises communication management service 630 and networking information 632. The operating software on storage system 645 may further include an operating system, utilities, drivers, network interfaces, applications, or some other type of software. When read and executed by processing system 650, the operating software on storage system 645 directs computing system 600 to operate as described herein.

In at least one implementation, networking information 632 is provided to computing system 600 by a coordination service that distributes networking or communication information to the computing systems in private networks. Here, networking information 632 includes communication information for multiple private networks, a primary private network and one or more alternative private networks. Networking information 632 includes private addressing information, public addressing information, encryption key information, and the like. When computing system 600 joins the private networks, communication management service 630 directs processing system 650 to provide at least public encryption key information (generated at computing system 600) to the coordination service and further provide public addressing information, such as a public IP address for computing system 600. Once provided, the coordination service distributes private addressing information for other computing elements, public addressing information for other computing elements, encryption information, or some other information for networking information 632. In some examples, the distributed information includes an indication of private IP addresses for computing system 600 including the address for the primary private network (i.e., the address used by applications on the computing element) and addresses for use in association with the alternative private networks.

After networking information 632 is received by computing system 600, communication management service 630 directs processing system 650 to identify a packet from a process on the computing element with a first source IP address. The first source IP address corresponds to a private IP address allocated to computing system 600 in association with the primary private network. For example, a video processing application can generate a packet directed to another computing element in a private network, wherein the packet includes the source IP address for the primary private network and a private destination IP address for the destination computing element. In response to identifying the packet, communication management service 630 directs processing system 650 to identify a destination private network from a plurality of private networks for the packet and determine whether the destination private network is a primary private network or a secondary private network.

In one example, when the packet is directed to a computing element in the primary private network, which is indicated in networking information 632, communication management service 630 directs processing system 650 to encapsulate the packet with the first source IP address and communicate the encapsulated packet toward a destination computing element. Specifically, because the destination IP address for the packet corresponds to a destination that is in the primary private network, computing system 600 is not required to perform network address translation on the source IP address.

In another example, when the packet is directed to a computing element in the secondary or alternate private network, communication management service 630 directs processing system 650 to perform network address translation to translate the first source IP address to a second source IP address for the secondary private network, encapsulate the packet with the second source IP address, and communicate the encapsulated packet toward a destination computing element. In at least one implementation, communication management service 630 identifies the private destination IP address in the packet and compares the private destination IP address to networking information 632. When the destination IP address corresponds to an alternative network (i.e., a network not defined as the primary network), communication management service 630 replaces the private source IP address with another source IP address for computing system 600 and associated with the alternative private network. Thus, computing system 600 is allocated multiple private IP addresses that are each associated with a different private network. However, to ease functionality of the different applications, the applications use a single private IP address (associated with the primary network) that is translated as necessary for the alternative private networks.

Although demonstrated in the previous example performing network address translation on the source IP address for an egress packet, similar operations are performed to ingress packets received from computing elements in the private network.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of operating a computing element comprising:
identifying a packet from a process on the computing element with a first source IP address;
identifying a destination private network from a plurality of private networks for the packet;
determining whether the destination private network is a primary private network or a secondary private network;
when the destination private network is a primary private network:
encapsulating the packet with the first source IP address to generate an encapsulated packet; and
communicating the encapsulated packet toward a destination computing element; and
when the destination private network is in a secondary private network:
performing network address translation to translate the first source IP address to a second source IP address for the secondary private network;
encapsulating the packet with the second source IP address; and
communicating the encapsulated packet toward a destination computing element.

2. The method of claim 1, wherein the computing element comprises a physical computer.

3. The method of claim 1, wherein the computing element comprises a virtual machine.

4. The method of claim 1 further comprising:
receiving a configuration from a coordination service, wherein the configuration comprises source IP addresses for the plurality of private networks, destination IP addresses for the plurality of private networks, encryption parameters for the plurality of private networks, and public destination IP addresses for the plurality of private networks.

5. The method of claim 1, wherein determining whether the destination private network is a primary private network or a secondary private network comprises:
identifying a destination IP address in the packet; and
determining whether the destination IP address corresponds to a destination in the primary private network of the secondary private network.

6. The method of claim 1, wherein encapsulating the packet with the first source IP address comprises:
identifying encryption parameters and a public IP address associated with a destination for the packet; and
encapsulating the packet in accordance with the encryption parameters and the public IP address, wherein the public IP address is placed in an encapsulation header for the encapsulated packet.

7. The method of claim 1, wherein encapsulating the packet with the second source IP address comprises:
identifying encryption parameters and a public IP address associated with a destination for the packet; and
encapsulating the packet in accordance with the encryption parameters and the public IP address, wherein the public IP address is placed in an encapsulation header for the encapsulated packet.

8. The method of claim 1 further comprising:
generating a request to join a first private network of the plurality of private networks, wherein the request indicates at least a public IP address for the computing element and a public encryption key for the computing element;
communicating the request to a coordination service; and
receiving a configuration from the coordination service from the coordination service, wherein the configuration comprises source IP addresses for the first private network, destination IP addresses for the first private network, encryption parameters, and public destination IP addresses for the first private network.

9. A computing element comprising:
a storage system;
a processing system operatively coupled to the storage system; and
program instructions stored on the storage system that, when executed by the processing system, direct the computing element to:
identify a packet from a process on the computing element with a first source IP address;
identify a destination private network from a plurality of private networks for the packet;
determine whether the destination private network is a primary private network or a secondary private network;
when the destination private network is a primary private network:
encapsulate the packet with the first source IP address to generate an encapsulated packet; and
communicate the encapsulated packet toward a destination computing element; and
when the destination private network is in a secondary private network:
perform network address translation to translate the first source IP address to a second source IP address for the secondary private network;
encapsulate the packet with the second source IP address; and
communicate the encapsulated packet toward a destination computing element.

10. The computing element of claim 9, wherein the computing element comprises a physical computer.

11. The computing element of claim 9, wherein the computing element comprises a virtual machine.

12. The computing element of claim 9, wherein the program instructions further direct the computing element to:
receive a configuration from a coordination service, wherein the configuration comprises source IP addresses for the plurality of private networks, destination IP addresses for the plurality of private networks, encryption parameters for the plurality of private networks, and public destination IP addresses for the plurality of private networks.

13. The computing element of claim 9, wherein determining whether the destination private network is a primary private network or a secondary private network comprises:
identifying a destination IP address in the packet; and
determining whether the destination IP address corresponds to a destination in the primary private network of the secondary private network.

14. The computing element of claim 9, wherein encapsulating the packet with the first source IP address comprises:
identifying encryption parameters and a public IP address associated with a destination for the packet; and
encapsulating the packet in accordance with the encryption parameters and the public IP address, wherein the public IP address is placed in an encapsulation header for the encapsulated packet.

15. The computing element of claim 9, wherein encapsulating the packet with the second source IP address comprises:
identifying encryption parameters and a public IP address associated with a destination for the packet; and
encapsulating the packet in accordance with the encryption parameters and the public IP address, wherein the public IP address is placed in an encapsulation header for the encapsulated packet.

16. The computing element of claim 9, wherein the program instructions further direct the computing element to:
generate a request to join a first private network of the plurality of private networks, wherein the request indicates at least a public IP address for the computing element and a public encryption key for the computing element;
communicate the request to a coordination service; and
receive a configuration from the coordination service from the coordination service, wherein the configuration comprises source IP addresses for the first private network, destination IP addresses for the first private network, encryption parameters, and public destination IP addresses for the first private network.

17. A system comprising:
a plurality of computers:
a first computer of the plurality of computers:
identify a packet from a process on the first computer with a first source IP address;
identify a destination private network from a plurality of private networks for the packet;
determine whether the destination private network is a primary private network or a secondary private network;
when the destination private network is a primary private network:
encapsulate the packet with the first source IP address to generate an encapsulated packet; and
communicate the encapsulated packet toward a destination computer in the plurality of computers; and
when the destination private network is in a secondary private network:
perform network address translation to translate the first source IP address to a second source IP address for the secondary private network;
encapsulate the packet with the second source IP address; and
communicate the encapsulated packet toward a destination computer.

18. The system of claim 17, wherein the first computer is further configured to receive a configuration from a coordination service, wherein the configuration comprises source IP addresses for the plurality of private networks, destination IP addresses for the plurality of private networks, encryption parameters for the plurality of private networks, and public destination IP addresses for the plurality of private networks.

19. The system of claim 18, wherein the system further comprises the coordination service executing on one or more additional computers.

20. The system of claim 18, wherein encapsulating the packet with the first source IP address comprises:
identifying encryption parameters and a public IP address associated with a destination for the packet; and
encapsulating the packet in accordance with the encryption parameters and the public IP address, wherein the public IP address is placed in an encapsulation header for the encapsulated packet.
